(19) United States
(12) Patent Application Publication
(10) Pub. No.: US 2008/0181340 A1
(43) Pub. Date: Jul. 31, 2008

(54) Spur Rejection Techniques for an RF Receiver

(75) Inventor: Adrian Maxim, Austin, TX (US)

Correspondence Address: LARSON NEWMAN ABEL POLANSKY & WHITE, LLP, 5914 WEST COURTYARD DRIVE, SUITE 200, AUSTIN, TX, 78730, US

(73) Assignee: SILICON LABORATORIES, INC., Austin, TX (US)

(21) Appl. No.: 11/669,762

(22) Filed: Jan. 31, 2007

(51) Int. Cl. H04B 1/10

(52) U.S. Cl. 375/346; 455/302

(57) ABSTRACT

A receiver (100) includes a mixing digital-to-analog converter (DAC) (120), a direct digital frequency synthesizer (DDFS) (116), and a clock circuit (114). The mixing DAC (120) includes a radio frequency (RF) transconductance section (124) and a switching section. The RF transconductance section (124) includes an input configured to receive an RF signal. The switching section (128) is coupled to the RF transconductance section (124) and includes inputs configured to receive bits associated with a digital local oscillator (LO) signal. The DDFS (116) includes outputs configured to provide the bits associated with the digital LO signal to the inputs of the switching section (128) and a first clock input configured to receive a first clock signal that sets a sample rate for the digital LO signal. The clock circuit (114) is configured to provide the first clock signal to the first clock input of the DDFS (116). A frequency of the first clock signal is based on a selected channel and the frequency of the first clock signal is configured to be set to substantially shift spurs that are not dependent on the RF signal out of a band of the analog output signal.

### FIELD OF THE DISCLOSURE

The present disclosure is generally directed to a radio frequency (RF) receiver and, more particularly, to techniques for improving spur rejection performance of an RF receiver.

### BACKGROUND

Reducing spurs in radio frequency (RF) receiver designs can be a relatively challenging task. Moreover, adequately addressing spur rejection in the design of broadband RF receivers that implement a direct digital frequency synthesizer (DDFS) in combination with a mixing digital-to-analog converter (DAC) may be particularly challenging. This is due to, at least in part, the fact that RF receivers that employ mixing DACs usually implement a relatively high clock signal frequency, e.g., 3 GHz, to generate digital local oscillator (LO) signals for the receivers. In such RF receivers, the mixing DAC has included an RF transconductance section and a switching section. The RF transconductance section has included an input that received an RF signal and an output that provided an RF current signal. The switching section has been coupled to the RF transconductance section and has included inputs that received bits associated with the digital LO signal, which has been provided at outputs of a direct digital frequency synthesizer (DDFS) based on a single high frequency clock signal.

The switching section has mixed the RF current signal with the digital LO signal to provide an analog output signal at an output of the switching section. The single frequency clock signal has set a sample rate for the digital LO signal, which has been based on a sampled sine wave. Unfortunately, RF receivers that employ a single high frequency clock signal to set a sample rate for a DDFS provided digital LO signal may have spur issues at combinations of the clock signal frequency and the LO signal frequency, as well as multiples thereof.

What is need is a technique for reducing spurs in an RF receiver that implements a direct digital frequency synthesizer (DDFS) in combination with a mixing digital-to-analog converter (DAC).

### SUMMARY

According to one embodiment, a receiver includes a mixing digital-to-analog converter (DAC), a direct digital frequency synthesizer (DDFS), and a clock circuit. The mixing DAC includes a radio frequency (RF) transconductance section and a switching section. The RF transconductance section includes an input configured to receive an RF signal and an output configured to provide an RF current signal. The switching section is coupled to the RF transconductance section and includes inputs configured to receive bits associated with a digital local oscillator (LO) signal and an output. The switching section is configured to mix the RF current signal with the digital LO signal to provide an analog output signal at the output of the switching section. The DDFS includes outputs configured to provide the bits associated with the digital LO signal to the inputs of the switching section and a first clock input configured to receive a first clock signal that sets a sample rate for the digital LO signal. The clock circuit is configured to provide the first clock signal to the first clock input of the DDFS. A frequency of the first clock signal is based on a selected channel and the frequency of the first clock signal is configured to be set to substantially shift spurs that are not dependent on the selected channel out of a band of the analog output signal.

According to another embodiment, a technique of reducing spurs in a radio frequency (RF) receiver includes determining a first image power of the RF receiver for a selected channel using low-side mixing. A second image power of the RF receiver for the selected channel is also determined using high-side mixing. The high-side or low-side mixing for the RF receiver is then selected based on whether the first or second image power is greater.

According to a different embodiment, a receiver includes a mixing digital-to-analog converter (DAC), a direct digital frequency synthesizer (DDFS), and a series-shunt regulator. The mixing DAC includes a radio frequency (RF) transconductance section and a switching section. The RF transconductance section includes an input configured to receive an RF signal and an output configured to provide an RF current signal. The switching section is coupled to the RF transconductance section and includes inputs configured to receive bits associated with a digital local oscillator (LO) signal and an output. The switching section is configured to mix the RF current signal with the digital LO signal to provide an analog output signal at the output of the switching section. The DDFS includes outputs, configured to provide the bits associated with the digital LO signal, and a first clock input, configured to receive a first clock signal that sets a sample rate for the digital LO signal. The series-shunt regulator is coupled between the DDFS and a first power supply node that is included within a first power supply loop. The first power supply node is configured to be coupled to a first power supply.

### BRIEF DESCRIPTION OF THE DRAWINGS

The present disclosure may be better understood, and its numerous features and advantages made apparent to those skilled in the art by referencing the accompanying drawings, in which:

FIG. 1 is an electrical diagram, in block and schematic form, of a relevant portion of a radio frequency (RF) receiver that implements a mixing digital-to-analog converter (DAC), configured according to an embodiment of the present invention;

FIG. 2. is an electrical diagram, in block and schematic form, of a relevant portion of an RF receiver whose phase locked loop (PLL) is configured to provide a variable frequency clock signal (f_{DDFS}) responsive to control of an input divider and a feedback divider to reduce spurs in the RF receiver, according to an embodiment of the present invention;

FIG. 3 is an electrical block diagram of a relevant portion of an RF receiver that is configured to switch between high-side and low-side mixing to reduce spurs in the RF receiver, according to an embodiment of the present invention;

FIG. 4 is an electrical diagram, in block and schematic form, illustrating spur coupling between an aggressor magnetic loop and a victim magnetic loop that may be present within an RF receiver;

FIG. 5 is an electrical diagram, in block and schematic form, illustrating use of a series-shunt regulator to power a direct digital frequency synthesizer (DDFS) employed within an RF receiver, according to an embodiment of the present invention;

FIG. 6 is an electrical diagram, in block and schematic form, of the diagram of FIG. 5 in further detail, according to an embodiment of the present invention;

FIG. 7 is an electrical diagram, in block and schematic form, illustrating the effect of quality factor on spur coupling between an aggressor magnetic loop and a victim magnetic loop that may be present within an RF receiver;

FIG. 8 is an electrical diagram, in block and schematic form, illustrating the use of capacitors, according to an embodiment of the present invention, to modify a resonance frequencies of an aggressor magnetic loop and a victim magnetic loop both of which may be present within an RF receiver;

FIG. 9 is an electrical block diagram, in block and schematic form, illustrating the use of a capacitor to modify a resonance frequency of victim magnetic loops that share a power supply and which may be present within an RF receiver;

FIG. 10 is a top level view of an integrated circuit (IC) that is configured, according to an embodiment of the present invention, to reduce spur coupling between a digital aggressor circuit and an analog victim circuit both of which may be present within an RF receiver;

FIG. 11 is a cross-sectional view of the IC of FIG. 10;

FIG. 12 is an electrical block diagram, in block and schematic form, illustrating potential coupling points for deep N-type wells associated with an aggressor magnetic loop and a victim magnetic loop of the IC of FIGS. 10 and 11, according to an embodiment of the present invention; and

FIG. 13 is a flow chart of a process for switching between high-side and low-side mixing to improve spur rejection of the RF receiver of FIG. 3.

The use of the same reference symbols in different drawings indicates similar or identical items.

### DETAILED DESCRIPTION

As noted above, reducing spurs in radio frequency (RF) receiver designs can be a relatively challenging task. As is also noted above, adequately addressing spur rejection in the design of broadband RF receivers (e.g., terrestrial/cable TV receivers) that implement a direct digital frequency synthesizer (DDFS) in combination with a mixing digital-to-analog converter (DAC) may be particularly challenging. In general, RF signal independent spurs may have frequencies at +/−N*f_{DDFS}+/−P*f_{LO}, where f_{DDFS} is a DDFS clock signal frequency and f_{LO} is a local oscillator (LO) signal frequency provided by the DDFS. As is typical, the LO signal is used to tune the RF receiver to a desired channel. In general, spurs may be attributed to power supply modulation of switching section (mixer) glitch energy or an LO modulated glitch due to finite output impedance of an RF transconductance section current path leg. In a typical RF receiver employing a mixing DAC, switching pairs (Gilbert cells) of the switching section of the mixing DAC switch in a local oscillator (LO) dependent fashion and, therefore, at the mixing DAC output there may be a relatively large LO impulse energy, due to the Cdv/dt current injection through parasitic capacitances associated with the switching pairs.

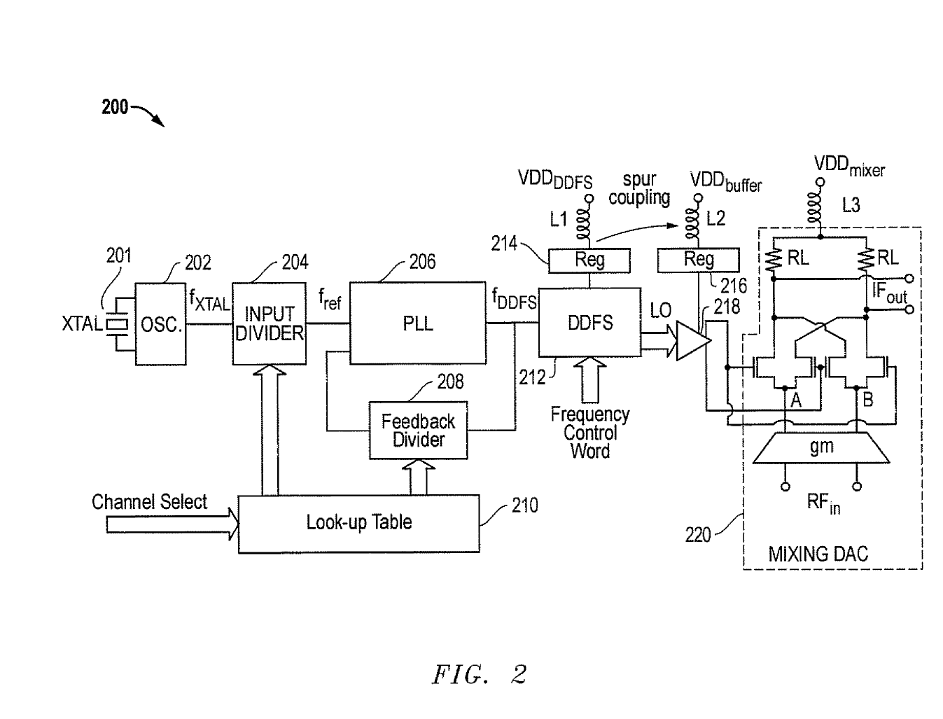

The current injected into an intermediate frequency (IF) path of the RF receiver may also depend on the final slewing value of a control signal provided by LO buffers. Due to the finite power supply rejection ratio (PSRR) at an associated power supply regulator, a large amount of the DDFS supply current impulse energy (at the DDFS clock signal frequency) may be coupled to the LO path and modulate the final value of the mixer control voltage. As such, at the output of the mixing DAC, a parasitic mixing effect may occur which multiplies the P*f_{LO} glitch energy by the N*f_{DDFS} supply injected tone. At common source points (see FIG. 2, points ‘A’ and ‘B’) of the switching pairs, the frequency appears doubled due to the rectification process that appears at the common mode points of a fully differential circuit. As such, at these common mode points, a relatively strong even order LO harmonic, e.g., 2 LO, 4 LO, etc., exists.

The finite output impedance of the current path leg at these high frequencies result in a tail current at 2LO, 4LO, etc. Moreover, switching of the switching pairs at the DDFS clock signal frequency, which is required to generate a sampled LO sine wave, results in switching at the DDFS clock signal frequency of the 2Q*LO tail current component. Unfortunately, this results in spurs at +/−N*f_{DDFS}+/−2Q*f_{LO}. In general, the spurs given by the two spur mechanisms that are relatively far outside the IF band are not usually important. That is, the amplitude of signals relatively far outside the IF band are strongly attenuated by the finite bandwidth of the IF path and, therefore, a down-conversion in the IF path, due to the non-linearity of the IF blocks, does not occur. However, the N*f_{DDFS}−P*f_{LO} and the P*f_{LO}−N*f_{DDFS} spurs may fall inside the IF band. In general, these spurs are independent of the amplitude of the RF signal and can significantly desensitize a tuner. Assuming the first spur mechanism (i.e., power supply modulation of switching section glitch energy) can be rejected by using a relatively high PSSR for the power supply regulators, the second spur mechanism (i.e., LO modulated glitch due to finite output impedance of the RF transconductance section current path leg) is still intrinsic to the mixing DAC architecture. The output impedance of the current path leg is limited by parasitic device capacitance which generally cannot be reduced further, assuming the layout is performed in a relatively compact manner with low layout capacitance.

For a given input channel (f_{RF}) and a given TV standard, an IF (f_{IF}) and an LO frequency (f_{LO}) are fixed. In such a case, the spur impact on the receiver sensitivity can be avoided if the spur frequency +/−N*f_{DDFS}+/−P*f_{LO} falls outside the 6 MHz or 8 MHz IF path band. According to various aspects of the present invention, spurs are moved out of the IF band by adjusting the DDFS clock signal frequency. While the discussion herein is primarily directed to moving spurs out of the IF band, it is contemplated that the techniques disclosed herein are directed to moving spurs out of other bands, e.g., a baseband. In a DDFS based local oscillator (LO) synthesizer, a frequency of an LO signal is not directly dependent on a frequency of a DDFS clock signal. However, the frequency of the LO signal is dependent on the DDFS accumulator setting. As such, even if the frequency of the DDFS clock signal is changed there exists a different accumulator setting that provides approximately the same LO signal frequency. In practice, a TV demodulator can usually handle a +/−100 kHz LO frequency error. Assuming a large enough DDFS accumulator size, it is possible to move a parasitic spur by +/−5 MHz, or more, such that the parasitic spur falls out of the IF band.

According to various aspects of the present invention, a frequency management technique is disclosed herein that modifies a direct digital frequency synthesizer (DDFS) clock frequency by manipulating one or more dividers associated with a phase locked loop (PLL) in an attempt to move signal independent spurs outside an intermediate frequency (IF) signal band of a radio frequency (RF) receiver. According to another frequency management technique, a complex RF receiver may be switched between high-side and low-side mixing to avoid or minimize both signal dependent (i.e., image signals) and signal independent spurs. According to this technique, a power of an image frequency is measured using both high-side mixing and low-side mixing. Then, an appropriate one of the high-side or low-side mixing is selected based upon which of the high-side and low-side mixing has a lower image frequency power.

A number of different circuit techniques may also be employed to improve the spur rejection of a complex RF receiver. According to one or more techniques, a configuration of digital block and analog block power supply regulators may be selected to improve spur rejection. Additionally, design techniques may be employed to avoid resonance frequencies in the power supply circuits. As used herein, a “radio frequency” signal means an electrical signal conveying useful information and having a frequency from about 3 kilohertz (kHz) to thousands of gigahertz (GHz), regardless of the medium through which such signal is conveyed. Thus, an RF signal may be transmitted through air, free space, coaxial cable, fiber optic cable, etc. As used herein, the term “coupled” includes both a direct electrical connection between elements or blocks and an indirect electrical connection provided by one or more intervening elements or blocks.

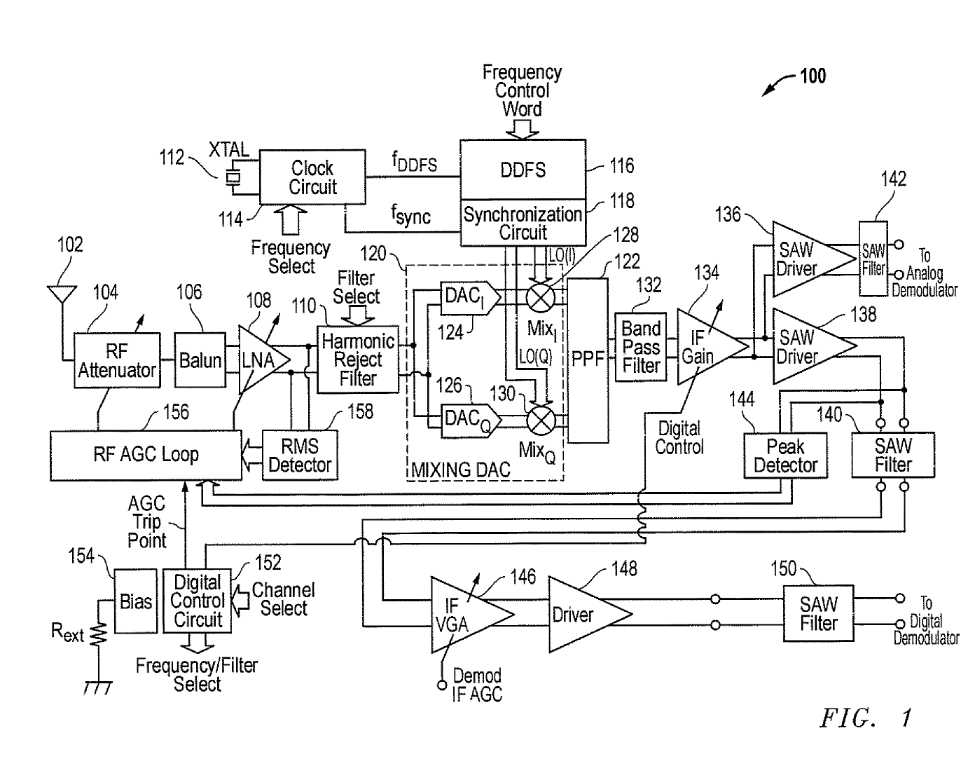

With reference to FIG. 1, an exemplary hybrid terrestrial/cable analog/digital television (TV) receiver (tuner) 100 is illustrated. The receiver 100 implements a direct digital frequency synthesizer (DDFS) 116 that drives a mixing digital-to-analog converter (DAC) 120, via a synchronization circuit 118, with a digital local oscillator (LO) signal. The synchronization circuit 118, which may include a master-slave latch structure and buffers, ensures that bits associated with quadrature LO signals (i.e., LO(I) and LO(Q)) arrive at respective inputs of the mixing DAC 120 at substantially similar arrival times. A clock circuit 114, which includes a phase locked loop (PLL), provides a DDFS clock signal (f_{DDFS}) to the DDFS 116 and a synchronization clock signal (f_{sync}) to the synchronization circuit 118. As is depicted, the receiver 100 includes an RF attenuator 104 that receives a TV signal from an antenna 102. An attenuation provided by the attenuator 104 is controlled by an RF automatic gain control (AGC) loop 156 such that strong incoming signals are adequately attenuated to avoid non-linearities (e.g., clipping) in an RF front-end, which includes low noise amplifier (LNA) 108 and the mixing DAC 120, etc. In general, the attenuator 104 should have a relatively low insertion loss such that it does not significantly impact noise figure performance of the receiver 100. The RF attenuator 104 may be implemented using, for example, an off-chip pin diode.

An output of the RF attenuator 104 is coupled to an input of a balun 106, which converts a signal at the output of the RF attenuator 104 into a differential signal, which is provided to a differential input of the LNA 108. In general, the balun 106 should have a relatively low insertion loss and a relatively good output amplitude and phase matching in order to minimize common mode to differential coupled noise/spur conversion at the input of the receiver 100. A 1 to N, e.g., a 1 to 2, balun can be used to provide gain in the signal path and, thus, reduce a noise contribution of active circuits in the receiver 100. While a balun can not provide power gain, i.e., it is a passive circuit, a balun can provide an impedance value change, e.g., from 75 Ohms to 300 Ohms in a 1 to 2 balun. By changing the reference impedance level, the noise figure of the receiver 100 may be improved.

The LNA 108 may be configured to have a programmable gain in discrete steps that is set by the RF AGC loop 156. In general, the LNA 108 should be designed to ensure good matching to the balun 106 output impedance. Outputs of the LNA 108 are respectively coupled to inputs of a programmable harmonic reject filter 110, which is configured to improve harmonic rejection performance of the receiver 100. At lower channel frequencies, e.g., in the VHF band, a low-pass filter may be employed to increase the blocker rejection of the LO harmonic frequencies, e.g., 2LO, 3LO, 4LO, etc. At higher channel frequencies, e.g., in the UHF band, a high-pass filter may be employed to reject harmonic distortion components generated by the LNA 108. When no harmonic issues exist, the filter 110 may be switched to an all-pass filter, such that the filter 110 does not degrade the noise figure performance of the receiver 100. It should be appreciated that the filter 110 may be realized as either a passive or an active filter. In general, passive filters have lower noise, but also exhibit lower harmonic rejection. In contrast, active filters provide a higher harmonic rejection, but generally exhibit larger noise contribution.

Outputs of the filter 110 are coupled to respective inputs of a mixing DAC 120, which in this case includes a pair of quadrature mixing DACs. The mixing DACs each have two main sub-blocks, i.e., RF transconductance sections 124 and 126 and switching sections (mixers) 128 and 130. The RF transconductance sections may be configured as, for example, RF transconductance DACs. The RF transconductance sections 124 and 126 convert an RF input voltage into an RF current, based on a value of each local oscillator (LO) bit provided by the DDFS 116. In general, a segmented DAC architecture offers a good power/performance compromise. Alternatively, a full binary encoded DAC or a full thermometer encoded DAC may be utilized. Typically, a full binary encoded DAC consumes lower power, but also exhibits lower linearity. In contrast, a full thermometer encoded DAC usually has higher linearity, but also requires higher power. In a typical application, the mixers 128 and 130 are configured as an array of switching pairs (Gilbert cells) that perform the mixing operation on a bit-by-bit basis. The mixer LO path includes a digital bus that provides a digital encoding, e.g., binary, thermometer, or segmented, of an instantaneous LO sampled sine wave to inputs of the mixers 128 and 130.

In general, the harmonic rejection of a mixing DAC depends both on the linearity of the RF transconductance section and on synchronization of DDFS control bit arrival times at the LO inputs of the mixers. As mentioned above, the outputs of the DDFS 116 are provided to inputs of the synchronization block 118. The DDFS 116 is driven by a first clock signal and the synchronization block 118 is driven by a second clock signal. The first and second clock signals may or may not have the same frequency, depending on whether the DDFS 116 is built as a single core or includes multiple cores. In general, the DDFS clock signal (f_{DDFS}) is less important in terms of phase noise and spurs since the LO data is synchronized later in the LO path. However, the second clock signal (f_{sync}) usually should have relatively low phase noise and low spurs, as the second clock signal determines the receiver phase noise and may impact the blocking performance of the receiver 100. The outputs of the mixers (MIX_{I} and MIX_{Q}) 128 and 130 are provided to a poly-phase filter (PPF) 122, e.g., a fifth-order PPF, that ensures a relatively high value image rejection level over a relatively wide intermediate frequency (IF) range that covers, for example, multiple TV standards, e.g., 33 MHz to 60 MHZ for Europe, USA, and Asian compliant TV receivers. The PPF 122 also performs complex-to-real conversion of the IF signal.

Outputs of the PPF 122 are coupled to respective inputs of bandpass filter 132. The bandpass filter 132 is implemented in the IF path in order to improve blocking performance of the receiver 100 and to lessen (or avoid) detection of blocker power by peak detector 144. The bandpass filter 132 may be implemented using a tuned active stage having an on-chip capacitance and an off-chip inductance that may be selected based on the TV standard. Outputs of the bandpass filter 132 are coupled to respective inputs of a programmable gain amplifier (PGA) 134 that sets the receiver 100 gain at a desired value based on the application, e.g., cable or terrestrial TV. As is depicted, an analog receiver path includes a surface acoustic wave (SAW) driver 136 that drives an off-chip SAW filter 142, whose output is coupled to an analog demodulator (not shown). An amplitude of a signal at the output of the driver 136 should generally be at least about 3 mV to ensure proper operation of an IF AGC loop. A digital receiver path includes a SAW driver 138 that drives an off-chip SAW filter 140, whose output is coupled to an input of an IF variable gain amplifier (VGA) 146. An output of the VGA 146 is coupled to an input of driver 148, whose output is coupled to an input of an off-chip SAW filter 150, whose output is coupled to an input of a digital demodulator (not shown). To reduce the cost of the receiver 100, the SAW filter 150 may be omitted and, in this case, the driver 148 would directly drive the digital demodulator.

In a typical analog/digital RF receiver, a digital demodulator does not include a built-in IF AGC variable gain amplifier (VGA). Thus, for digital TV applications, an additional 50 to 65 decibel (dB) gain is usually required, depending on SAW filter insertion loss, to provide a desired amplitude at an analog-to-digital converter (ADC) input of the digital demodulator. In this embodiment, the VGA 146 is employed to provide a desired gain and gain range. To avoid clipping of the signals at the RF front-end and at an output of IF path SAW driver 138, a dual RF/IF AGC loop may be implemented. In this case, a gain of both the RF attenuator 104 and the LNA 108 are set by the AGC loop 156, based on a power level sensed by an RF root mean square (RMS) detector 158 and peak signal level sensed by the peak detector 144 (at the SAW driver 138 output). A variable AGC trip point can be set via a digital control interface circuit 152, which also sets the gain in the IF path and control parameters for the clock circuit 114 and the DDFS 116. A bias circuit 154 may be employed that utilizes a high precision external resistor (Rₑₓₜ) to accurately set bias current and voltage levels required for proper operation of the receiver 100.

With reference to FIG. 2, a relevant portion of an RF receiver 200 is depicted that is configured, according to an embodiment of the present invention, to employ a frequency management technique to reduce spurs. As is shown, the receiver 200 includes a crystal (XTAL) 201 that is coupled to an input of crystal oscillator 202, whose output is coupled to a first input of a programmable input divider 204. An output of the divider 204 is coupled to a first input of a phase locked loop (PLL) 206, whose output is coupled to a clock input of a direct digital frequency synthesizer (DDFS) 212. A programmable feedback divider 208 is coupled between the output of the PLL 206 and a second input of the PLL 206. In operation, the PLL 206 provides a channel appropriate DDFS clock signal to the clock input of the DDFS 212. A frequency of the DDFS clock signal is equal to f_{XTAL}*(feedback divider/input divider), where f_{XTAL} corresponds to a reference frequency provided by the oscillator 202.

In general, the goal is to shift a frequency of the DDFS clock signal such that spurs at +/−N*f_{DDFS}+/−P*f_{LO} fall out of the IF band (e.g., centered at 44 MHz and having a 6 MHz bandwidth) for a selected channel. Typically, this can be achieved by selecting proper values for the input divider 204 and the feedback divider 208 from look-up table 210, based on a selected channel. As is shown, the look-up table 210 receives a channel select signal and outputs respective control signals to inputs of the dividers 204 and 208. Outputs of the DDFS 212 are coupled to control inputs of switching section (switching pairs) of mixing digital-to-analog converter (DAC) 220, via buffers 218 (only one of which is shown). A synchronization circuit (not shown in FIG. 2) may also be employed between the DDFS 212 and the buffers 218 to ensure that bits associated with an LO signal, provided by the DDFS 212, arrive at the control inputs of the switching section of the mixing DAC 220 at substantially the same time. The DDFS 212 is coupled to a first power supply (VDD_{DDFS}) via a bond-wire (L1) and a power supply regulator 214 (e.g., a series-shunt regulator). Similarly, the buffers 218 are coupled to a second power supply (VDD_{buffer}) via a bond-wire (L2) and a power supply regulator 216 (e.g., a series regulator) and the mixing DAC 220 is coupled to a third power supply (VDDₘᵢₓₑᵣ) via a bond-wire (L3).

It should be appreciated that different spurs move at different speeds, given by +/−N*f_{DDFS}+/−P*f_{LO}. For example, for N equal to 1, for each MHz frequency shift of the DDFS clock signal, the spurs also move by 1 MHz. As another example, for N equal to 2, for each MHz frequency shift of the DDFS clock signal, the spurs move by 2 MHz. In general, spurs move by N MHz for each MHz of frequency change in the DDFS clock signal. As there may be several sets of spurs moving at different speeds and in both positive and negative directions (based on the +/−N*f_{DDFS} sign) at an output of a mixing DAC, it is possible that while one spur may be moved out of the IF band another spur may be moved into the IF band.

To reduce the occurrence of this event, a DDFS clock signal frequency shifting increment of a relatively small value may be desirable. Usually, having a 2 MHz or 4 MHz frequency increment is suitable to move all spurs out-of-band. Typically, a voltage control oscillator (VCO) of a PLL needs to have a relatively wide tuning range to accommodate the frequency management technique. Since the +/−N*f_{DDFS}+/−P*f_{LO} spurs have a predetermined position, the TV spectrum may be characterized for the discrete LO frequencies required by terrestrial/cable applications and a look-up table may be implemented, e.g., in hardware. In this case, the look-up table provides a PLL clock frequency for each LO signal frequency to ensure that all spurs are moved out of the IF band. That is, for each LO setting the look-up table provides appropriate settings for the input and feedback dividers 204 and 208 to achieve a desired frequency for the DDFS clock signal. In the event that the DDFS implements multiple DDFS cores that operate at 1/S of a desired frequency, additional spurs may also appear in the form of +/−N*f_{DDFS}/S+/−P*f_{LO}, where S is the number of DDFS cores. In general, if a relatively large number of spurs exist, a smaller frequency increment and a wider PLL tuning range are required to ensure that all spurs fall out of the IF band.

Another solution to avoid fixed frequency signal independent spurs is to switch between high-side and low-side mixing, as the LO frequencies required for high-side and low-side mixing are different and are likely to move the +/−N*f_{DDFS}+/−P*f_{LO} spurs out of the IF band. In this case, DDFS clock signal frequency is kept constant (at a high-side or a low-side frequency) and high-side mixing or low-side mixing is employed, depending on whether high-side mixing or low-side mixing has less spur issues. In general, the difference between the two LO frequencies is 2f_{IF} which results in a 2*P*f_{IF} shift of the spur frequency, typically moving the spur out of the IF band. In general, in a receiver including a DDFS driven mixing DAC, it is relatively simple to switch between high-side and low-side complex mixing by implementing a multiplexer between the DDFS and the mixing DAC. The multiplexer is used to direct a cosine to in-phase (I) inputs and a sine to quadrature (Q) inputs of the mixing DAC for high-side mixing and the sine to the I inputs and the cosine to Q inputs of the mixing DAC for low-side mixing. It should be appreciated that the value of a DDFS register is also required to be changed to set an LO signal to an appropriate frequency.

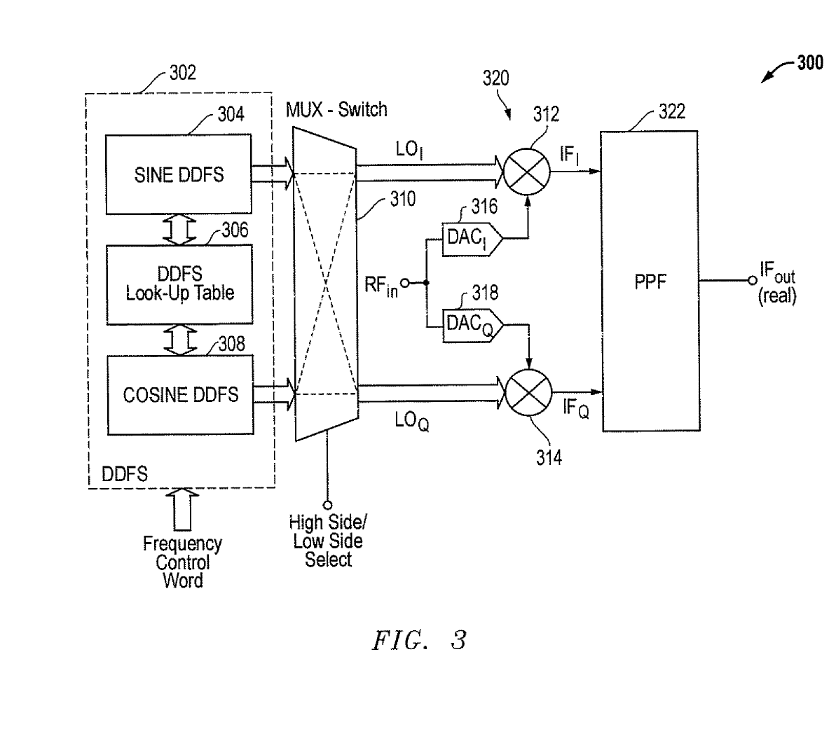

With reference to FIG. 3, a relevant portion of a complex RF receiver 300 is depicted that is configured to switch between high-side and low-side mixing. The receiver 300 includes a direct digital frequency synthesizer (DDFS) 302 that includes a DDFS look-up table 306 that, responsive to a frequency control word, provides appropriate sampled values for sine or cosine waveforms. The table 306 is coupled to a sine DDFS block 304 and to a cosine DDFS block 308. The sine DDFS block 304 provides digital bits that correspond to a sine LO signal and the cosine DDFS block 308 provides digital bits that correspond to a cosine LO signal. The sine and cosine LO signals are provided to respective inputs of a multiplexer 310, whose first outputs are coupled to control inputs of switching section (mixer) 312 and whose second outputs are coupled to control inputs of switching section (mixer) 314. The mixers 312 and 314 are included within a mixing DAC 320, which also includes RF transconductance sections 316 and 318. When high-side mixing is selected, the cosine LO signal is routed to control inputs of the mixer 312 and the sine LO signal is routed to control inputs of the mixer 314. When low-side mixing is selected, the sine LO signal is routed to control inputs of the mixer 314 and the cosine LO signal is routed to control inputs of the mixer 312. Outputs of the mixer 312 are coupled to first inputs of the poly-phase filter (PPF) 322 and outputs of the mixer 314 are coupled to second inputs of the PPF 322.

Typically, digital demodulators of an analog/digital RF receiver can process both a high-side and a low-side mixed signal. Normally, the difference between the two situations is an image of the frequency spectrum. However, analog demodulators of analog/digital RF receivers can generally only handle high-side mixing. In the analog demodulator case, the DDFS clock signal frequency management technique may be employed to address spur issues. Another draw back of the high-side/low-side mixing swap is that the frequency shift, i.e., 2*P*f_{IF}, is rather coarse and while moving one spur out of the IF band the approach may move another spur into the IF band. However, employing the high-side/low-side mixing technique may be particularly advantageous when spurs are signal dependent. As the terrestrial TV spectrum is not that densely populated, in most cases, if a blocking channel is present at an image frequency for high-side injection it is generally not present at an image frequency for low-side injection, due to the relatively large separation between the image frequencies for the two modes. For example, assuming high-side mixing in a receiver that employs an intermediate frequency f_{IF} of 44 MHz and having a desired channel frequency f_{desired} centered at 100 MHz, a local oscillator frequency f_{LO} of 144 MHz would be employed and an image frequency f_{image} would be located at 188 MHz. For low-side mixing in a receiver that employs an intermediate frequency f_{IF} of 44 MHz and having a desired channel frequency f_{desired} centered at 100 MHz, a local oscillator frequency f_{LO} of 56 MHz would be employed and an image frequency f_{image} would be located at 12 MHz.

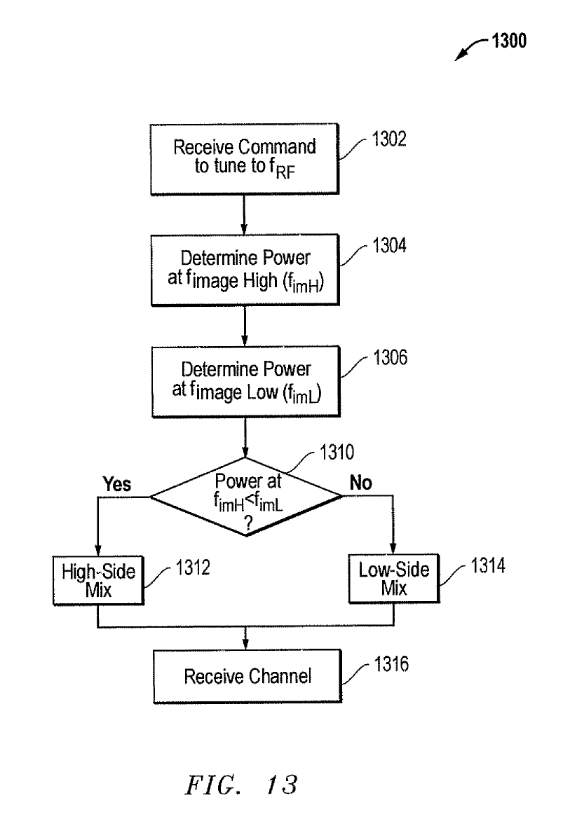

According to various embodiments of the present invention, and with reference to FIG. 13, a process 1300 for implementing a high-side/low-side mixing technique is depicted. In block 1302, a receiver receives a command to tune to a selected channel (f_{RF}). In a typical case, the receiver may first be configured to receive an image frequency of the selected channel in a high-side mode. In this case, at block 1304, an output power at an image frequency (f_{imH}) is determined for the high-side mode. The receiver is then configured to receive an image frequency of the selected channel in a low-side mode. In block 1306, an output power at an image frequency (f_{imL}) is determined for the low-side mode. Next, in decision block 1310, the receiver determines whether the image power in the high-side mode is less than the image power in the low-side mode. If the image power is lower in the high-side mode, control transfers from block 1310 to block 1312, where high-side mixing is employed. If the image power is higher in the high-side mode, control transfers from block 1310 to block 1314, where low-side mixing is employed. Following blocks 1312 or 1314, control transfers to block 1316 where the channel is received in the selected mode. In this manner, a signal-to-noise ratio (SNR) degradation, due to finite image rejection, may be reduced.

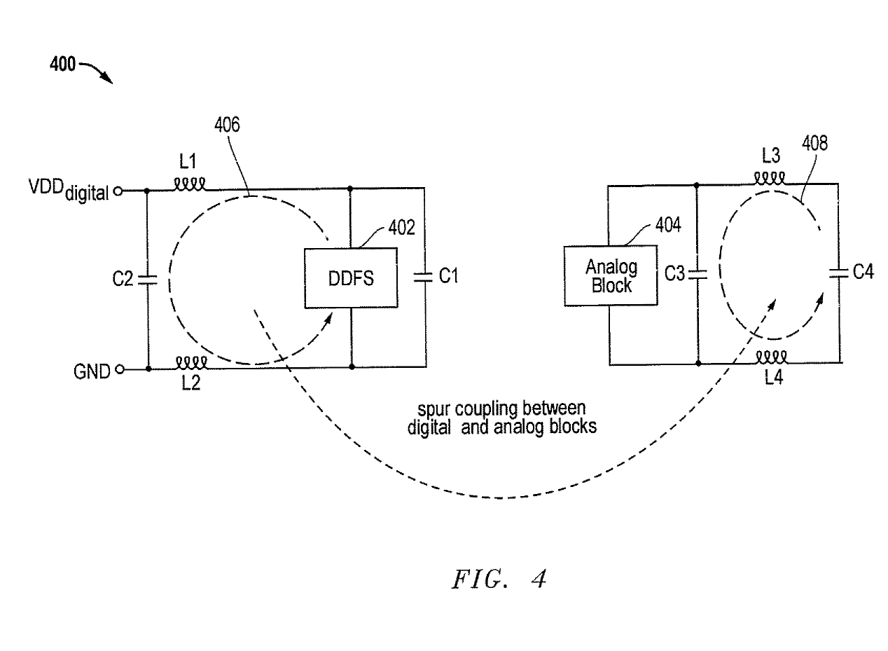

In a typical mixed-signal integrated circuit (IC) broadband RF receiver, e.g., a system on a chip (SOC), that employs a mixing digital-to-analog (DAC) based architecture, the largest amount of digital noise/spurious tones is usually generated by a direct digital frequency synthesizer (DDFS) that drives the mixing DAC. As such, achieving a low spur level RF receiver requires good isolation of digital blocks (e.g., the DDFS) from analog blocks (e.g., the analog front-end and other analog components). In general, the lowest RF receiver power dissipation can be achieved by using a minimal digital power supply voltage with no regulation or filtering. However, if the DDFS impulse power supply current, e.g., the current attributable to the switching of the digital gates and flip-flops, is allowed to flow through a power supply bond-wire, an off-chip external bypass capacitor and return on-chip through a ground bond-wire, then a relatively large magnetic loop may exist that strongly couples spurs to a magnetic loop that contains analog front-end power supply bond-wires. With reference to FIG. 4, an electrical diagram 400 illustrates spur coupling between a DDFS 402 and an analog circuit (block) 404, e.g., an analog RF front-end. As is illustrated, an aggressor magnetic loop 406 is formed by the DDFS 402, power supply (VDD_{digital}) bond-wires L1 and L2, and off-chip bypass capacitor C2. Similarly, a victim magnetic loop 408 is formed by power supply (VDD_{analog}) bond-wires L3 and L4, off-chip bypass capacitor C4, and on on-chip bypass capacitor C3.

Due to finite power supply rejection ratio (PSRR) and common mode to differential gain of the analog RF front-end, digital coupled spurs may end up in the RF signal path and desensitize the receiver. In general, improving a forward PSRR of regulators that are used to bias the REF front-end and improving matching in the differential stages of the RF front-end does not reduce spur levels below a desired noise floor level. The RF front-end cannot usually implement an arbitrarily large device size to provide low common mode to differential gain, due to parasitic capacitance (associated with large device sizes) that limits signal path bandwidth. In general, spur coupling may be reduced by minimizing an area of a victim magnetic loop. Moreover, spur coupling from the aggressor magnetic loop can be reduced by: increasing a distance between aggressor and victim magnetic loops; ensuring 90 degree, or as close as possible, orientation between the aggressor and victim magnetic loops; reducing the area of the aggressor magnetic loop; and reducing the amount of impulse current going through the aggressor magnetic loop.

Typically, employing a standard series regulator for a digital load does not substantially reduce the amount of impulse current flowing through a power supply bond-wire, as an output impedance of the series regulator is generally lower than a reactance of an on-chip load capacitance (C_{L}) placed across the digital load (e.g., a DDFS) up to moderately high frequencies. To minimize the amount of impulse power supply current that flows through a power supply bond-wire, a parallel (shunt) regulator may be implemented. If all devices are in normal active state, then an impedance (an output impedance of a DC bias current source (I_{BIAS})) looking toward the power supply bond-wire is relatively large. In this case, the DDFS impulse current is substantially maintained on-chip and, as such, a smaller loop results that has relatively low radiation. Moreover, a high frequency load current component flows through the load capacitance C_{L} and a medium frequency load current component flows through a local feedback loop that includes a transistor M_{FEED}.

During proper operation of a shunt power supply regulator (shunt regulator), a DC bias current is provided that is higher than a highest instantaneous load current. When the load current is smaller than the DC bias current, the excess DC bias current flows through a shunt loop including the transistor M_{FEED}. Unfortunately, the shunt regulator has relatively poor power efficiency as DC bias current is wasted in the shunt loop when the load current is smaller than a peak load current. Typically, DDFS cores operating at multi-GHz frequencies require relatively large power supply currents, e.g., several hundreds of milliamperes on the average and up to several amperes of peak current. As such, shunt regulators alone are usually impractical in RF receivers that employ a DDFS in conjunction with a mixing DAC.

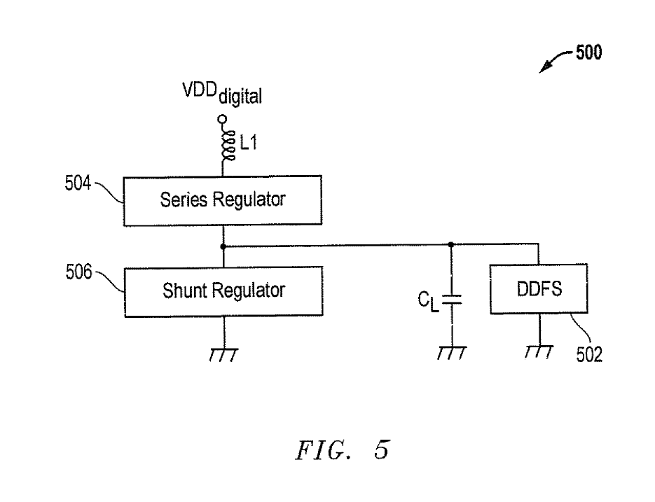

Turning to FIG. 5, a hybrid power supply regulator (i.e., a series-shunt power supply regulator) 500 is employed to power a direct digital frequency synthesizer (DDFS) 502. In this architecture, a main DC current for the DDFS 502 is provided by a series regulator 504, while high frequency impulse current is provided by a shunt regulator 506 and its parallel bypass capacitor C_{L}. An advantage of using the series regulator 504 is that the series regulator 504, as contrasted with a shunt regulator, provides a required DC bias current for the DDFS 502 without wasting current. At high frequencies, the shunt regulator 506 and the load capacitor C_{L} offer a low impedance locally to the digital impulse current, which substantially prevents the digital impulse current from flowing through the supply bond-wire.

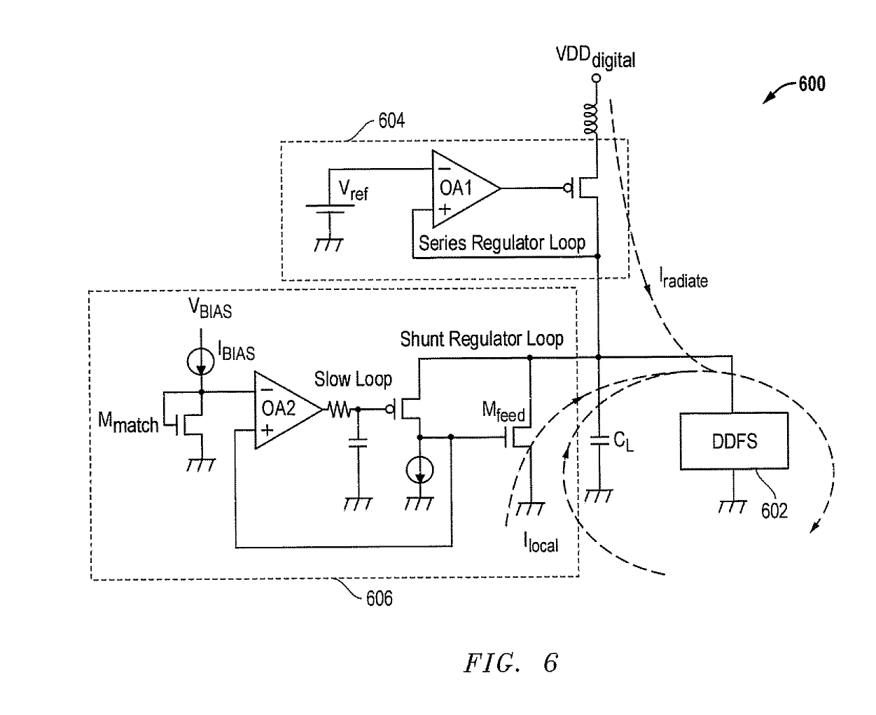

Moving to FIG. 6, a hybrid series-shunt regulator 600 is illustrated that includes a series regulator 604 and a shunt regulator 606 that are employed to power a DDFS 602, while reducing the ability of the DDFS 602 to radiate spurs. In general, the higher the bandwidth of the shunt regulator 606 loop, the more current is carried by transistor M_{FEED}. It should, however, be appreciated that achieving a high bandwidth requires a high transconductance and, thus, usually requires a relatively large current consumption in the shunt regulator 606. A good compromise between power and reverse PSRR may be achieved by using 1/10 or ⅕ of the total DDFS DC current in the shunt loop. Typically, using a relatively large value load capacitance C_{L} improves the reverse PSRR at medium and high frequencies. Employing a series-shunt regulator allows a reverse PSRR of 40 to 60 decibel (dB) to be achieved. However, in many broadband receiver applications, e.g., a terrestrial TV receiver, an overall PSRR of −75 to −85 decibel (dB) is desirable. In this case, using a series-shunt regulator, by itself to isolate a DDFS from the analog blocks of the receiver is not usually sufficient. To increase the PSRR, additional regulators with high forward PSSR may be implemented to power various analog blocks. The combination of the reverse PSRR at the series-shunt regulator and the forward PSRR at the front-end circuitry bias regulators can usually provide spur levels of −75 to −85 dBc (dB with respect to the carrier).

In general, to improve the isolation between digital and analog circuits, the digital and analog circuits should implement separate power supply lines. However, as previously discussed, magnetic coupling may occur between the different power supply circuits. In general, power supply bond-wire inductances and, on-chip and off-chip bypass capacitors constitute a poorly damped inductor capacitor (LC) circuit that has a relatively large quality factor (Q). When the frequency of operation is relatively far from the LC resonance frequency, the current circulating in the aggressor magnetic loop is relatively small. However, if the aggressor circuit frequency is close to or at the LC circuit resonance frequency, then the current in the aggressor magnetic loop is boosted by the quality factor (Q) value, which is typically in the range of 10 to 50. Thus, even if a small amount of current is injected in the aggressor magnetic loop, the injected current can generate a relatively large coupling effect in the victim magnetic loop. To address this situation, an on-chip bypass capacitor may be employed to modify the resonance frequency of the aggressor magnetic loop.

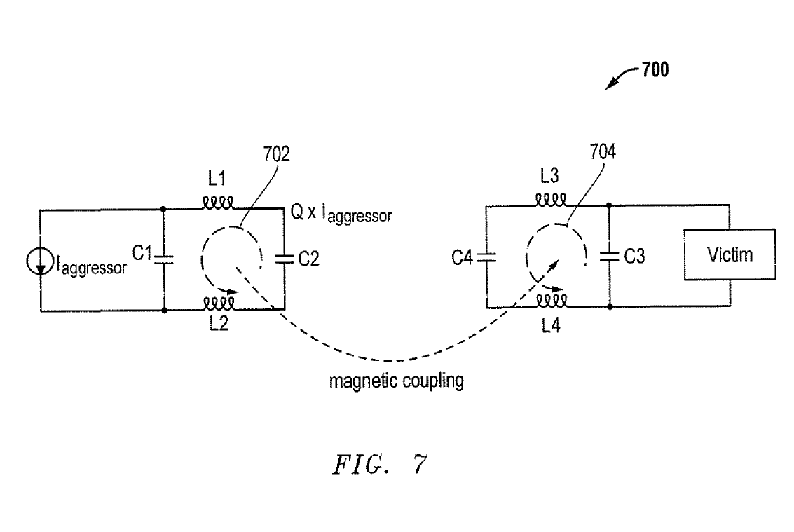

With reference to FIG. 7, a circuit diagram 700 illustrates magnetic coupling between an aggressor magnetic loop 702 and a victim magnetic loop 704 and the effect of resonance on magnetic coupling between the loops 702 and 704. The victim magnetic loop 704 is formed by an off-chip capacitor C4, an on-chip capacitor C3, and bond-wires L3 and L4. The aggressor magnetic loop 702 is formed by on-chip capacitor C1, off-chip capacitor C2, and bond-wires L1 and L2. As is depicted, a current (I_{aggressor}) that flows through the aggressor magnetic loop 702 is multiplied by a quality factor (Q) of the LC circuit that forms the aggressor magnetic loop 702.

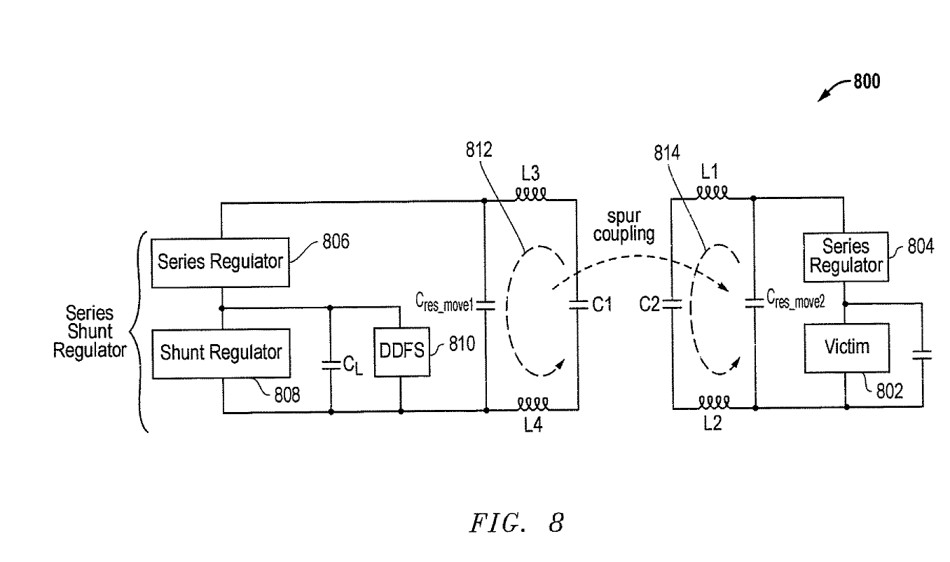

With reference to FIG. 8, a circuit diagram 800 illustrates coupling between an aggressor magnetic loop 812 and a victim magnetic loop 814 and the use of added on-chip bypass capacitors (Cres_move1 and Cres_move2) to move a resonance frequency of the aggressor and victim magnetic loops 812 and 814, respectively, to reduce coupling. As is shown, an aggressor circuit includes a DDFS 810 that receives power via a series regulator 806 and a shunt regulator 808. A load capacitor C_{L} is positioned to filter power delivered, via the regulators 806 and 808, to the DDFS 810. A victim circuit 802 receives power via a series regulator 804. The aggressor magnetic loop 812 is provided by the on-chip capacitor Cres_move1, an off-chip capacitor C1, and bond-wires L3 and L4. The victim magnetic loop 814 is provided by the on-chip capacitor Cres_move2, an off-chip capacitor C2, and bond-wires L3 and L4.

A value of the on-chip bypass capacitor Cres_move1 should usually be selected to ensure that the resonance frequency is either lower or higher than the spectrum of induction for the DDFS 810. However, in DDFSs that operate at multi-GHz frequencies it may be relatively difficult to move the resonance frequency higher, due to the finite on-chip bypass capacitance that exists intrinsically in the circuit. In this case, one solution is to move the resonance frequency lower to avoid current boosting in the aggressor magnetic loop 812. A similar situation exists in the victim side where the power supply circuit has a poorly damped LC circuit with a given resonance frequency. As noted above, the victim resonance frequency may be moved out of the aggressor frequency range by adding a sufficient value on-chip bypass capacitor Cres_move2.

In addition to the DDFS coupled spurs, the analog front-end may produce spurs that should not be coupled to other analog circuits. For example, in a mixing DAC based receiver, the mixer LO path buffers and synchronization latches have parasitic spurs at f_{LO}, f_{DDFS}, f_{DDFS}+/−f_{LO}, 2f_{DDFS}+/−f_{LO}, etc. In general, the worst resonance frequency to deal with is at f_{DDFS}, where a substantial amount of energy usually exists. In parallel DDFS architectures, f_{DDFS}/S is of concern, where S is the number of DDFS cores in parallel. In various applications, e.g., terrestrial/cable TV, the minimum frequency of interest is around 40 MHz. In general, it is not possible to move the LC resonance frequency of the power supply lines lower than the lowest channel of interest by using a reasonable capacitor value for an on-chip bypass capacitor. In this case, one solution is add enough capacitance to move the resonance frequency far from the major spurious tone frequencies, e.g., f_{DDFS} and f_{DDFS}/S. Typically, a few hundred MHz resonance frequency shift may be realized with capacitances having a value of hundreds of picofarads. Assuming the resonance is still in the TV band, current boosting still occurs. When channels still experience spur problems, a frequency management teclnique, such as swapping high-side and low-side mixing, may be employed. In general, the combination of moving the power supply current resonance frequency and the avoidance of the LO channels that create the spurs around the resonance frequency provides a receiver that has relatively low spur coupling.

Usually, minimizing the cost of an RF receiver requires minimizing the number of pins of an integrated circuit (IC) package of the receiver. The requirement of a low number of package pins typically prevents the implementation of separate power supply pins for each IC block. As such, in any given design, several blocks typically share the same supply pins. According to various aspects of the present invention, some of the blocks may use a regulator and some of the blocks may be directly coupled to power supply lines. In a standard regulator design, a filter capacitor C_{L} is connected in parallel with a load. The capacitance that appears on a power supply line magnetic loop includes a parasitic capacitance of a power supply regulator. This parasitic capacitance, in general, is poorly controlled over process, temperature, and supply corners. Moreover, in the case of multiple power supply regulators that have a common power supply, the sum of the parasitic capacitances of all the power supply regulators should be considered. At typical bond-wire inductance values and usual device parasitic capacitances, the resonance frequency of a receiver implementing a multi-regulator architecture is in the GHz range and, therefore, spurs may fall on the f_{DDFS} or f_{DDFS}/S frequencies.

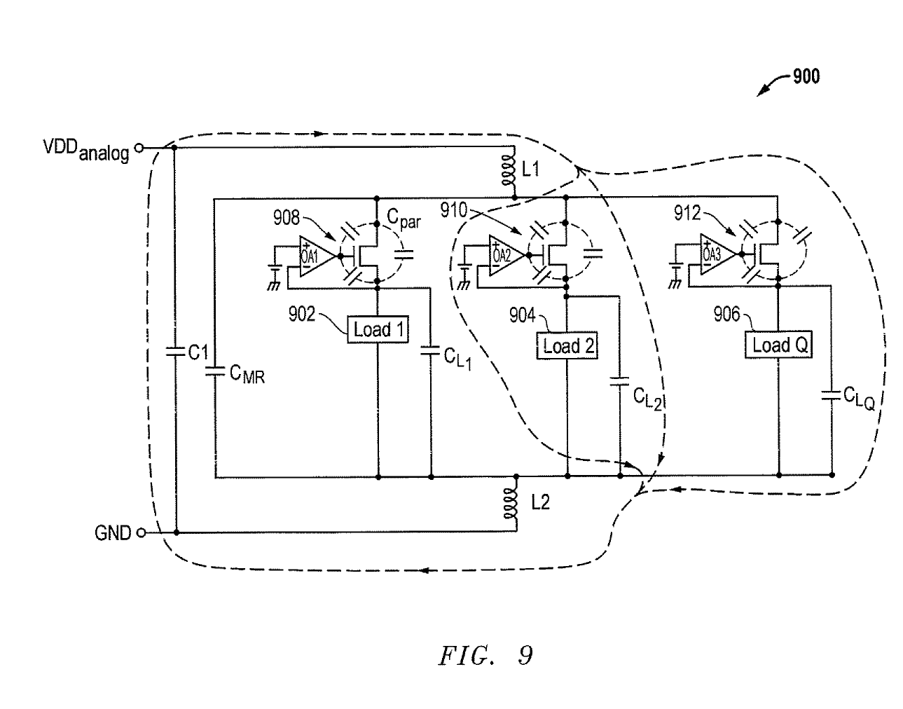

With reference to FIG. 9, a circuit 900 is illustrated that includes three analog circuits (loads) that share the same power supply. The loads 902, 904, and 906, each utilize separate series regulators 908, 910, and 912, respectively. To address the potential spur problem created in the circuit 900, a relatively large value capacitor C_{MR} may be placed directly between the power supply VDD_{analog} lines to move the resonance frequency to lower frequencies. As disclosed above, spur boosting at the resonance frequency may be addressed by using various frequency management techniques.

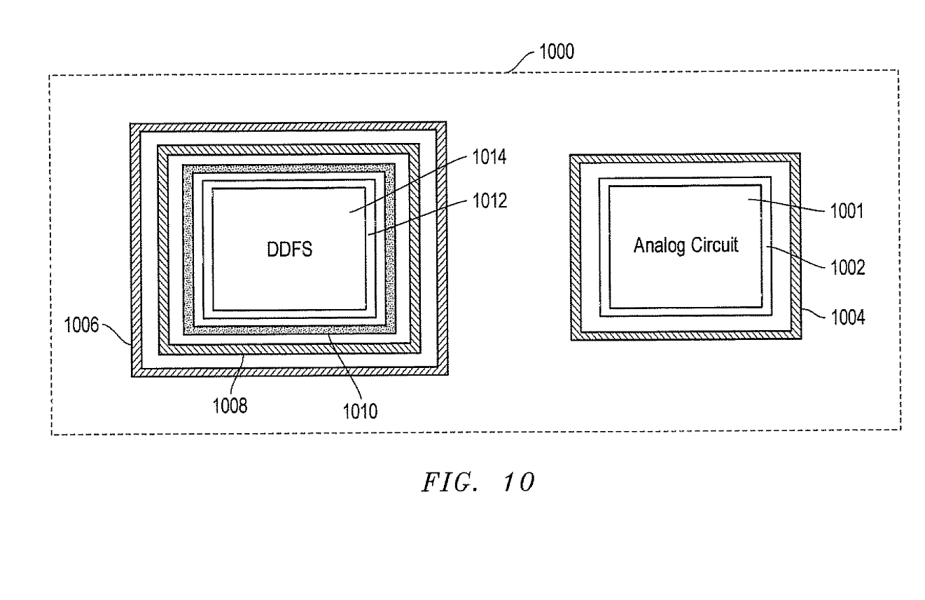

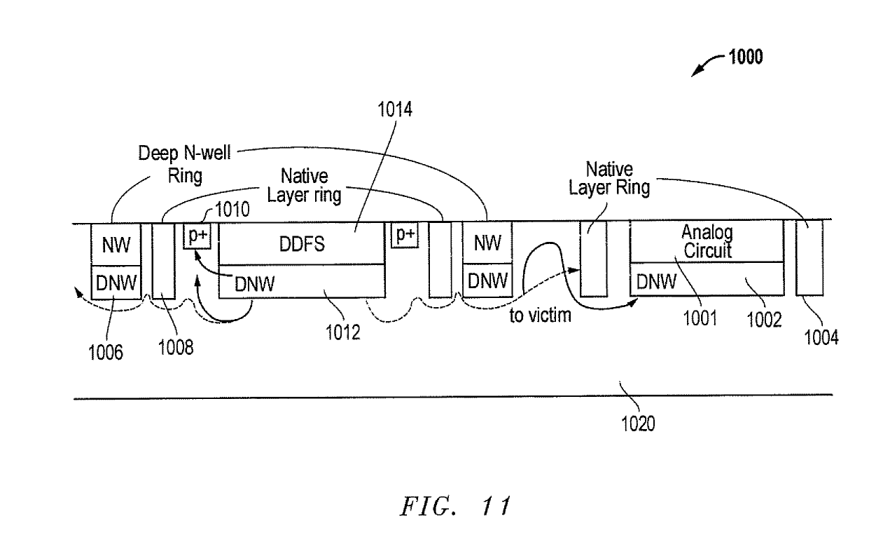

Another concern in large mixed-signal system on chips (SOCs) is substrate spur coupling between digital and analog circuits (blocks). In such an SOC, digital and analog blocks are realized on the same die, i.e., substrate, and, as such, there is a finite amount of coupling between the different blocks through the substrate. FIGS. 10 and 11 depict an SOC 1000 that includes a DDFS 1014 that is formed in a first deep N-type well (DNW) 1012 and an analog circuit 1001 that is formed in a second deep N-type well (DNW) 1002. While placing digital and analog circuits in separate deep N-type wells provides relatively good isolation at low frequencies, at high frequencies (where most spur energy exists), a parasitic capacitance of a deep N-type well may provide a short which reduces an isolation level between the digital and analog blocks.

In a typical receiver, a digital block is generally relatively large as compared to analog blocks and, as such, a parasitic capacitance of the digital block is relatively large. To minimize coupling between the digital and analog blocks, the deep N-type well of an analog block may be made as small as possible to reduce parasitic capacitance. However, in receivers that achieve image and harmonic rejection natively, i.e., with no analog or digital correction or calibration, analog circuits need to have a relatively large area to provide the required matching. For example, a mixing DAC needs to have a relatively large area to ensure high DAC linearity and, thus, good harmonic and image rejection. In this case, additional guard rings may be employed around the digital block (aggressor) and the analog blocks (victims) to improve isolation. For example, additional guard rings 1008 and 1004 may be employed around the DDFS 1014 and the analog circuit 1001 to improve isolation.

For the aggressor digital block, P+ substrate ties, which are electrically connected by a substrate 1020 ground bond-wire L5 to an off-chip ground, should be located at a minimum distance from the digital block edge. For example, P+ substrate ties may be formed as a P+ ring 1010. Locating the P+ ring 1010 relatively close to the DDFS 1014 ensures a relatively low resistance for the substrate-to-ground connection and causes noise injected (by, for example, the digital block) into the substrate 1020 to follow this path, without coupling to the analog circuit 1001. The rings 1008 and 1004 may be native layer rings that have a high resistivity. The ring 1008 presents a high resistance in series with a coupled spur path and, thus, reduces the amount of noise traveling to the analog circuit 1001.

Outside the ring 1008, a second stacked deep N-type well (DNW) and N-type well (NW) wall 1006 may be located to further reduce digital noise contamination of the substrate 1020 surface. As the silicon is lower doped in the volume than at the surface, placing a stacked N-type well wall in the noise path forces the noise to go around the wall which causes the noise to see a higher volume resistance of the substrate 1020. On the victim side, the ring 1004 is positioned to further reduce the noise reaching the analog circuit 1001. In a typical design, the rings 1008 and 1004 are low-doped layers that are provided free in modern deep submicron (e.g., less than 0.13 microns) complementary metal-oxide semiconductor (CMOS) processes. In contrast, the deep N-type well layer requires extra masks and, thus, has an associated additional cost.

In terrestrial/cable TV receivers, employing mixing DAC architectures, the DDFS usually needs to be operated at more than two times the highest LO frequency. If several parallel DDFS cores are implemented to address digital circuit speed issues, then f_{DDFS}/S can be around a few GHz, e.g., 1 GHz. A large f_{LO}+/−1 GHz spur can down-convert a large blocker channel (f_{blocker}) at 1 GHz−f_{blocker} on top of the desired channel (f_{RF}=f_{LO}−f_{IF}). The constraints for these signal dependent spurs are relatively demanding, e.g., less than −75 dB, particularly in hybrid analog/digital terrestrial receivers. In general, this requires special consideration and minimization of the f_{DDFS}/S power supply and substrate injected spurs. In this case, frequency management may only move the position of the blocker channel to another sensitive blocker position. When this occurs, one solution is to implement multi-ground ring isolation to reduce the substrates spur injection and a multiple series-regulator approach with high forward PSSR for regulators on the victim side and a series-shunt regulator for the digital block with the proper connection of the deep N-type wells.

In general, local oscillator (LO) path circuitry of a mixing DAC includes multiple analog blocks, which may include a clock buffer, synchronization latches, and output buffers that drive a switching section of the mixing DAC. In order to provide proper biasing for the mixing DAC, the output buffers in the LO path generally require a larger voltage than other LO path components. As such, the output buffers usually use a separate buffer regulator. Any deterministic, i.e., data dependent, ripple coupled to the clock buffer may cause additional jitter on the synchronization clock resulting in degraded phase noise performance of the receiver. Minimizing coupling of data dependent ripple from the synchronization latches of the LO path to the clock buffer of the LO path may be achieved by using separate series regulators, e.g., a clock regulator and a latch regulator. In a typical application, a clock buffer power supply regulator should exhibit a relatively high PSRR value. To reduce spur rejection in the LO path, a relatively well balanced differential data path should generally be employed.

It should be appreciated that where a deep N-type well of an IC is connected affects the operation of a receiver. Connecting the deep N-type well of the LO path at a regulated voltage is usually not desirable as substrate noise may be injected into a local power supply without being attenuated by a power supply regulator PSRR. A relatively good choice is to connect the LO path deep N-type well to an unregulated side of a power supply.

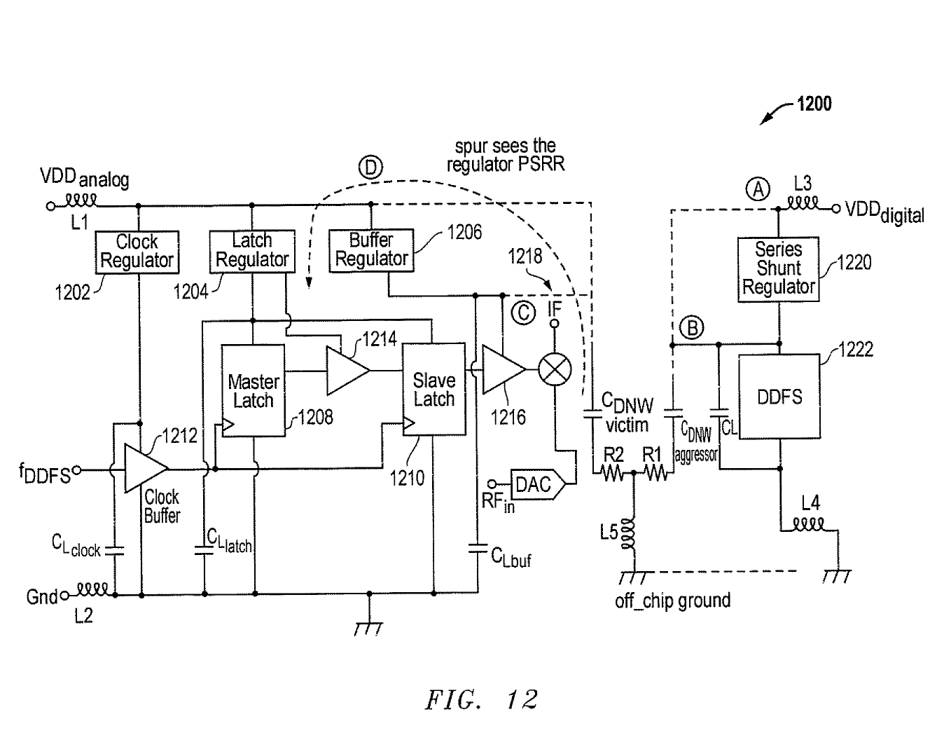

With reference to FIG. 12, a relevant portion of a receiver 1200 is depicted that includes a DDFS 1222 that receives power from a power source (VDD_{digital}), via bond-wires L3 and L4, and series-shunt regulator 1220. The receiver 1200 also includes series regulators 1202, 1204, and 1206 that are coupled to a power supply (VDD_{analog}) via bond-wires L1 and L2. A clock buffer 1212 receives power via the series regulator 1202. Master-slave latches 1208 and 1210 and buffers 1214 receive power via the series regulator 1204 and buffers 1216 receive power from the series regulator 1206. An aggressor deep N-type well associated with DDFS 1222 may be coupled at point A or point B and a victim deep N-type well associated with the clock buffer 1212, latches 1208 and 1210 and buffers 1214 and 1216 may be coupled at point C or point D. As noted above, it is usually preferable to couple deep N-type wells of analog and digital blocks to an unregulated side of an associated power supply (see FIG. 12, points A and D). In this case, substrate noise is injected into the unregulated power supply where it may be attenuated by a power supply regulator PSRR.

Accordingly, frequency management techniques have been disclosed herein that move the DDFS clock signal frequency such that spurs fall out-of-band. Swapping of high-side/low-side mixing may be employed to move a spur out of the IF band or to select a lower power spur. A hybrid series-shunt regulator may be employed to power a digital block to maintain current impulses on-chip and, thereby, minimize the area of an aggressor magnetic loop. The resonance of the digital block power supply lines may also be adjusted to move the resonance frequency of the power supply lines away from the DDFS generated spurs. Multiple regulators may be employed on sensitive analog circuits to reduce the impact of magnetically coupled spurs from the digital block. Relatively large bypass capacitors may also be implemented to move the victim supply line resonance frequencies away from major DDFS spurs. A guard ring may also be employed within an integrated circuit (IC) to reduce power supply injected spurs. In one or more embodiments, an IC may employ guard rings, substrate ties, a relatively wide high resistivity ring and a stacked N-type well/deep N-type well wall on the aggressor side and a second relatively wide high resistivity ring on the victim side. Substrate noise coupling may also be reduced by connecting the isolation deep N-type well rings directly to an unregulated power supply, both on the aggressor and the victim sides. In general, coupled spurs are attenuated by the reverse PSRR of the digital block hybrid series shunt-shunt regulator and by the forward PSSR of the power supply series regulator(s) used by the analog circuits.

The above-disclosed subject matter is to be considered illustrative, and not restrictive, and the appended claims are intended to cover all such modifications, enhancements, and other embodiments that fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A receiver, comprising:
a mixing digital-to-analog converter (DAC), comprising:
a radio frequency (RF) transconductance section having an input configured to receive an RF signal and an output configured to provide an RF current signal; and
a switching section coupled to the RF transconductance section, the switching section having inputs for receiving bits associated with a digital local oscillator (LO) signal and having an output, wherein the switching section is configured to mix the RF current signal with the digital LO signal to provide an analog output signal at the output of the switching section;
a direct digital frequency synthesizer (DDFS) having outputs configured to provide the bits associated with the digital LO signal and having a first clock input configured to receive a first clock signal that sets a sample rate for the digital LO signal; and
a clock circuit configured to provide the first clock signal to the first clock input of the DDFS, wherein a frequency of the first clock signal is based on a selected channel, and wherein the frequency of the first clock signal is configured to be set to substantially shift spurs that are not dependent on the selected channel out of a band of the analog output signal.

2. The receiver of claim 1, wherein the clock circuit further comprises:
an oscillator including an output configured to provide a first reference clock signal having a first reference frequency;
an input divider having an input coupled to the output of the oscillator and an output;
a phase locked loop (PLL) having a first input coupled to the output of the input divider and an output configured to provide the first clock signal to the first clock input of the DDFS; and
a feedback divider coupled between the output of the multiplexer and an input of the PLL, wherein values of the input and feedback dividers are configured to be set based on the selected channel.

3. The receiver of claim 2, wherein the clock circuit further comprises:
a look-up table coupled to the input divider and the feedback divider, wherein the look-up table is configured to set the values of the input and feedback dividers based on the selected channel.

4. The receiver of claim 1, wherein the outputs of the DDFS include in-phase (I) outputs and quadrature (Q) outputs and the inputs of the switching section include first control inputs coupled to an in-phase (I) portion of the switching section and second control inputs coupled to a quadrature (Q) portion of the switching section, and wherein the receiver further comprises:
a multiplexer having first inputs coupled to the I outputs of the DDFS, second inputs coupled to the Q outputs of the DDFS, first outputs coupled to the first control inputs and second outputs coupled to the second control inputs, wherein the multiplexer selectively couples the first outputs of the DDFS to the first or second control inputs and the second outputs of the DDFS to an opposite one of the first and second control inputs based on a power level at an image frequency of the selected channel in a high-side and low-side mixing configuration.

5. The receiver of claim 1, wherein the frequency of the first clock signal is also selected to shift spurs that are dependent on the selected channel out of the band of the analog output signal.

6. The receiver of claim 1, wherein the mixing DAC includes quadrature mixing DACs for, respectively, providing an in-phase (I) output signal and a quadrature (Q) output signal.

7. The receiver of claim 1, wherein a first power supply loop associated with the DDFS is configured to reduce spur coupling between the DDFS and an analog circuit of the receiver.

8. The receiver of claim 7, further comprising:
a series-shunt regulator coupled between the DDFS and a first power supply node that is included within the first power supply loop.

9. The receiver of claim 7, further comprising:
a first capacitor positioned across the first power supply loop approximate the DDFS, wherein the first capacitor is selected to change a first resonance frequency of the first power supply loop to reduce spur radiation associated with the first power supply loop.

10. The receiver of claim 9, further comprising:
a second capacitor positioned across a second power supply loop approximate the analog circuit, wherein the second capacitor is selected to change a second resonance frequency of the second power supply loop to reduce spur coupling into the second power supply loop.

11. The receiver of claim 7, wherein the analog circuit includes multiple analog circuits that are coupled to a second power supply node that is configured to be coupled to a second power supply, and wherein the receiver further comprises:
multiple series power supply regulators, wherein a respective one of the multiple series power supply regulators is coupled between a different one of the multiple analog circuits and the second power supply node; and
a second capacitor positioned across a second power supply loop approximate the analog circuits, wherein the second power supply loop includes the second power supply node and the second capacitor is selected to change a second resonance frequency of the second power supply loop to reduce spur coupling into the second power supply loop.

12. A method of reducing spurs in a radio frequency (RF) receiver, comprising:
determining a first image power of the RF receiver for a selected channel using low-side mixing;
determining a second image power of the RF receiver for the selected channel using high-side mixing; and
selecting the high-side or low-side mixing for the RF receiver based on whether the first or second image power is greater.

13. The method of claim 12, wherein the determining the first image power further comprises:
tuning a direct digital frequency synthesizer (DDFS) of the RF receiver to a first image frequency associated with a low-side local oscillator (LO) frequency for the selected channel; and
measuring the first image power of the RF receiver for the selected channel.

14. The method of claim 13, wherein the determining a second image power further comprises:
tuning the DDFS of the receiver to a second image frequency associated with the high-side LO frequency for the selected channel; and
measuring the second image power of the RF receiver for the selected channel.

15. A receiver, comprising:
a mixing digital-to-analog converter (DAC), comprising:
a radio frequency (RF) transconductance section having an input for receiving an RF signal and an output configured to provide an RF current signal; and
a switching section coupled to the RF transconductance section, the switching section having inputs for receiving bits associated with a digital local oscillator (LO) signal and having an output, wherein the switching section is configured to mix the RF current signal with the digital LO signal to provide an analog output signal at the output of the switching section;
a direct digital frequency synthesizer (DDFS) having outputs configured to provide the bits associated with the digital LO signal to the inputs of the switching section and having a first clock input for receiving a first clock signal that sets a sample rate for the digital LO signal; and
a series-shunt regulator coupled between the DDFS and a first power supply node that is included within a first power supply loop, wherein the first power supply node is configured to be coupled to a first power supply.

16. The receiver of claim 15, further comprising:
a clock circuit configured to provide the first clock signal to the first clock input of the DDFS, wherein a frequency of the first clock signal is based on a selected channel, and wherein the frequency of the first clock signal is selected to substantially shift spurs that are not dependent on the selected channel out of a band of the analog output signal.

17. The receiver of claim 16, wherein the frequency of the first clock signal is also selected to shift spurs that are dependent on the selected channel out of the band of the analog output signal.

18. The receiver of claim 15, further comprising:
a first capacitor positioned across the first power supply loop approximate the DDFS, wherein the first capacitor is selected to change a first resonance frequency of the first power supply loop to reduce spur radiation associated with the first power supply loop.

19. The receiver of claim 18, wherein the first power supply loop is configured to reduce spur coupling between the DDFS and an analog circuit of the receiver, and wherein the receiver further comprises:
a second capacitor positioned across a second power supply loop approximate the analog circuit, wherein the second capacitor is selected to change a second resonance frequency of the second power supply loop to reduce spur coupling into the second power supply loop.

20. The receiver of claim 19, wherein the analog circuit includes multiple analog circuits, and wherein the receiver further comprises:
multiple series power supply regulators, wherein a respective one of the multiple series power supply regulators is coupled between a different one of the multiple analog circuits and a second power supply node that is included within the second power supply loop.
